(19) United States
(12) Patent Application Publication
(10) Pub. No.: US 2023/0004866 A1
(43) Pub. Date: Jan. 5, 2023

(54) AI MODEL LEARNING METHOD AND SYSTEM BASED ON SELF-LEARNING FOR FOCUSING ON SPECIFIC AREAS

(71) Applicant: Korea Electronics Technology Institute, Seongnam-si (KR)

(72) Inventors: Choong Sang CHO, Seongnam-si (KR); Young Han LEE, Yongin-si (KR)

(73) Assignee: Korea Electronics Technology Institute, Seonganm-si (KR)

(21) Appl. No.: 17/852,531

(22) Filed: Jun. 29, 2022

(30) Foreign Application Priority Data
Jun. 30, 2021 (KR) 10-2021-0085413

(51) Int. Cl. G06N 20/00; G06K 9/62

(52) U.S. Cl. CPC G06N 20/00; G06K 9/6259

(57) ABSTRACT

There are provided AI model learning method and system based on self-learning for focusing on specific areas. According to an embodiment, a network learning system includes: a detection module configured to detect a specific area from unlabeled images, and to generate unlabeled area images; a configuration module configured to configure self-learning data by using the generated area images; and a learning module to cause a backbone network to perform self-learning by using the configured self-learning data. Accordingly, an AI model may be trained based on self-learning for focusing on a desired specific area according to a desired purpose, and high-performance analysis specified for various purposes and characteristics of various types of specific areas is possible.

### CROSS-REFERENCE TO RELATED APPLICATION(S) AND

### CLAIM OF PRIORITY

This application is based on and claims priority under 35 U.S.C. § 119 to Korean Patent Application No. 10-2021-0085413, filed on Jun. 30, 2021, in the Korean Intellectual Property Office, the disclosure of which is herein incorporated by reference in its entirety.

### BACKGROUND

### Field

The disclosure relates to artificial intelligence (AI) technology, and more particularly, to a method and a system for training an AI model for analyzing visual information to be appropriate to specific purposes and specific areas.

### Description of Related Art

Now, utilizing AI technology is indispensable to image analysis, and, with the ongoing development of technology, the time has come when an AI model can learn through self-learning as well as supervised learning.

Currently, performing self-learning with reference to an entire input image and learning features of the image is a mainstream of the technology for analyzing images by using an AI model.

However, such a learning method does not focus on specific areas that should be analyzed, and accordingly, there is a problem that performance of recognition/determination of the corresponding areas is degraded.

### SUMMARY

The disclosure has been developed to address the above-discussed deficiencies of the prior art, and an object of the present disclosure is to provide AI model learning method and system based on self-learning for focusing on specific areas, as a solution for enhancing performance of analysis of an AI model on specific areas.

According to an embodiment of the disclosure to achieve the above-described object, a network learning system includes: a detection module configured to detect a specific area from unlabeled images, and to generate unlabeled area images; a configuration module configured to configure self-learning data by using the generated area images; and a learning module to cause a backbone network to perform self-learning by using the configured self-learning data.

In addition, the specific area may include a face area, an object area, a semantic area, and an entire area.

According to an embodiment of the disclosure, the network learning system may further include a first selection module configured to select a backbone network to learn the configured self-learning data, and the learning module may cause the selected backbone network to perform self-learning.

According to an embodiment of the disclosure, the network learning system may further include a second selection module configured to select a learning method for the backbone network to learn the self-learning data, and the learning module may cause the backbone network to perform self-learning in the selected learning method.

The learning method may include a first learning method by which the backbone network learns to make an output of the backbone network follow an output of a target network, and a second learning method by which the backbone network learns while estimating an augmentation method of augmented self-learning data.

The configuration module may configure unlabeled self-learning data by shuffling the area images when the first learning method is selected by the second selection module.

The configuration module may configure self-learning data by augmenting the area images and labeling with an augmentation method when the second leaning method is selected by the second selection module.

According to an embodiment of the disclosure, the network learning system may further include an optimization module configured to cause the self-learned backbone network to additionally learn with labeled area images.

A number of labeled images used for generating labeled area images may be less than a number of unlabeled images.

According to another embodiment of the disclosure, a network learning method includes: detecting a specific area from unlabeled images, and generating unlabeled area images; configuring self-learning data by using the generated area images; and causing a backbone network to perform self-learning by using the configured self-learning data.

According to another embodiment of the disclosure, a network learning system includes: a database in which unlabeled images are stored; a detection module configured to detect a specific area from the unlabeled images stored in the database, and to generate unlabeled area images; a configuration module configured to configure self-learning data by using the generated area images; and a learning module to cause a backbone network to perform self-learning by using the configured self-learning data.

According to another embodiment of the disclosure, a network learning method includes: storing unlabeled images; detecting a specific area from the unlabeled images stored, and generating unlabeled area images; configuring self-learning data by using the generated area images; and causing a backbone network to perform self-learning by using the configured self-learning data.

According to embodiments of the disclosure as described above, an AI model may be trained based on self-learning for focusing on a desired specific area according to a desired purpose, and high-performance analysis specified for various purposes and characteristics of various types of specific areas is possible.

### BRIEF DESCRIPTION OF THE DRAWINGS

FIG. 1 is a view illustrating an AI model learning system according to an embodiment of the disclosure;

FIG. 2 is a view provided to explain a specific area detection module shown in FIG. 1;

FIG. 3 is a view provided to explain a backbone network selection module shown in FIG. 1;

FIG. 4 is a view provided to explain a learning method selection module shown in FIG. 1;

FIG. 5 is a view provided to explain a learning data configuration module shown in FIG. 1; and

FIG. 6 is a view illustrating a hardware structure for implementing the learning system of FIG. 1.

### DETAILED DESCRIPTION

Hereinafter, the disclosure will be described in detail with reference to the accompanying drawings.

Embodiments of the disclosure provide a self-learning-based image analysis system for focusing on a desired specific area. To achieve this, in an embodiment of the disclosure, a type of a specific area may be selected and self-learning data may be configured.

Furthermore, in an embodiment of the disclosure, a backbone network to be used for image analysis may be freely selected, and a self-learning method for the backbone network may be freely selected.

In addition, in an embodiment of the disclosure, supervised learning may be added to complement self-learning, and a backbone network may be optimized for analysis of specific areas.

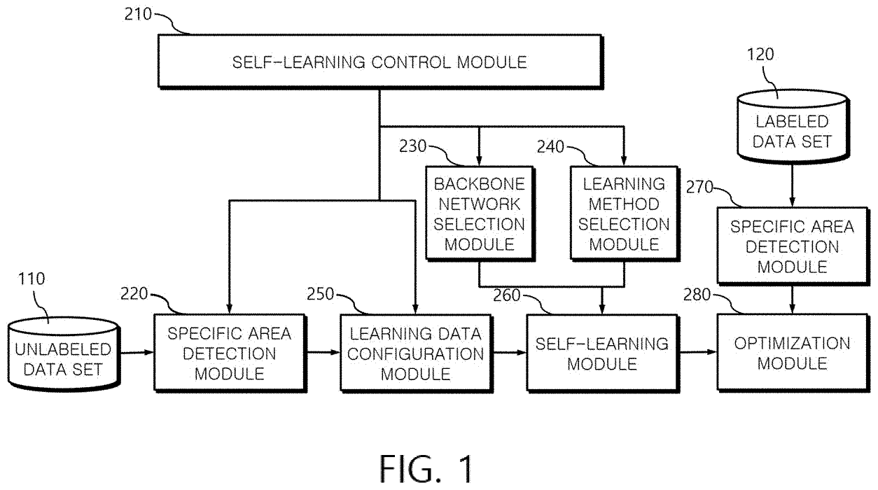

FIG. 1 is a view illustrating an AI model learning system according to an embodiment of the disclosure. As shown in FIG. 1, the learning system according to an embodiment may include an unlabeled data set 110, a self-learning control module 210, a specific area detection module 220, a backbone network selection module 230, a learning method selection module 240, a learning data configuration module 250, a self-learning module 260, a labeled data set 120, a specific area detection module 270, an optimization module 280.

The self-learning control module 210 may be a module for controlling matters related to self-learning in the learning system according to an embodiment. To achieve this, the self-learning control module 210 may determine a specific area to be detected by the specific area detection module 220, a backbone network to be selected by the backbone network selection module 230, a learning method to be selected by the learning method selection module 240, and self-learning data to be configured by the learning data configuration module 250, and accordingly, may control the corresponding modules 220, 230, 240, 250.

The unlabeled data set 110 may be a database in which unlabeled images are stored as self-learning data.

The specific area detection module 220 may detect a specific area from the unlabeled images stored in the unlabeled data set 110, and may generate unlabeled specific area images.

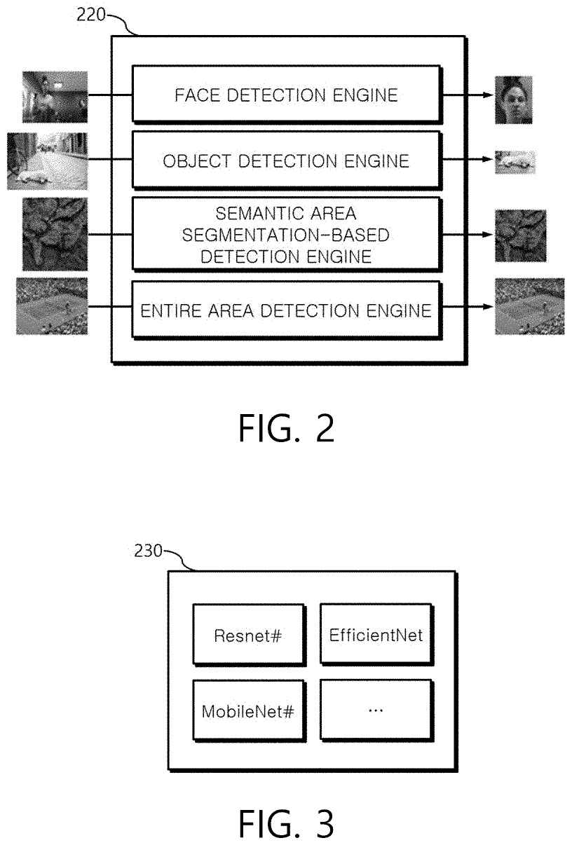

As shown in FIG. 2, the specific area detection module 220 may include a plurality of detection engines for detecting a face area, an object (person, car, dog) area, a semantic area (road, mountain, building, etc.), and an entire area (all areas), and may detect only corresponding areas by using the engines.

A type of a specific area detected by the specific area detection module 220 may be selected by the above-described self-learning control module 210. That is, only an engine for detecting a specific area selected by the self-learning control module 210 may be activated in the specific area detection module 220.

The semantic area segmentation-based detection engine may clip areas to include all of segmented semantic areas, thereby generating a specific area image.

The backbone network selection module 230 may be a module for selecting a backbone network for self-learning. The backbone network may be configured with deep learning networks of a convolution neural network (CNN) structure used for image classification as shown in FIG. 3.

The backbone network selected by the backbone network selection module 230 may be determined by the above-described self-learning control module 210.

The learning method selection module 240 may be a module for selecting a self-learning method by which the backbone network selected by the backbone network selection module 230 learns self-learning data.

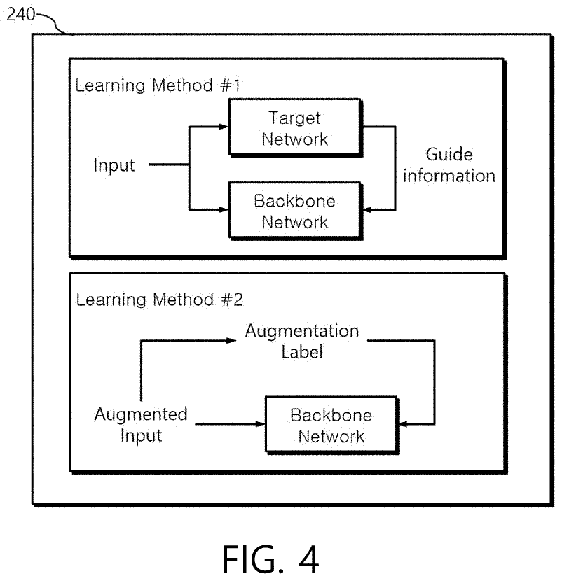

Two types of self-learning methods selectable by the learning method selection module 240 are suggested in FIG. 4.

Self-learning method #1 may be a self-learning method by which the backbone network learns to make an output of the backbone network follow an output of a target network, that is, learns in such a way that a loss between the output of the backbone network and the output of the target network is reduced.

Self-learning method #2 may be a self-learning method by which the backbone network learns while estimating an augmentation method of augmented self-learning data. To achieve this, augmenting self-learning data and labeling the augmented self-learning data with an augmentation method should precede.

The self-learning method selected by the learning method selection module 240 may be determined by the above-described self-learning control module 210.

The learning data configuration module 250 may configure self-learning data based on a self-learning method selected by the learning method selection module 240, by using the specific area images acquired by the specific area detection module 220.

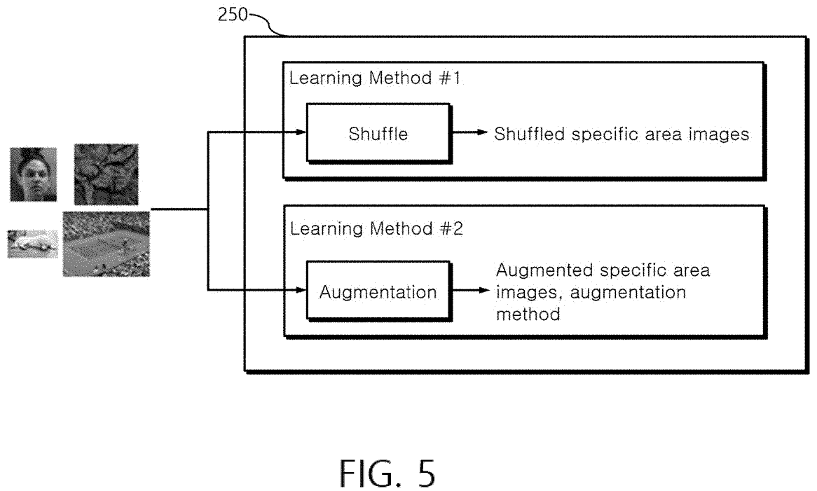

Specifically, as shown in FIG. 5, when self-learning method #1 is selected by the learning method selection module 240, the learning data configuration module 250 may only configure unlabeled self-learning data by shuffling the specific area images.

On the other hand, when self-learning method #2 is selected by the learning method selection module 240, the self-learning data configuration module 250 may configure self-learning data by augmenting the specific area images and labeling the augmented specific area images with an augmentation method.

The self-learning module 260 may cause the backbone network selected by the backbone network selection module 230 to perform self-learning in the self-learning method selected by the learning method selection module 240, by using the self-learning data configured by the learning data configuration module 250.

When self-learning is completed, the self-learning module 260 may store weights of the backbone network which completes self-learning.

The optimization module 280 may be a module that optimizes the backbone network which completes self-learning by the self-learning module 260 through additional leaning by using labeled area images.

To achieve this, the optimization module 280 may receive the weights stored in the self-learning module 260, first, and may configure a backbone network, thereby generating a self-learned backbone network.

Next, the optimization module 280 may train the generated backbone network through supervised learning, and training data for this may be generated by the specific area detection module 270. Specifically, the specific area detection module 270 may detect a specific area from labeled images which are stored in the labeled data set 120, and may generates labeled specific area images.

The optimization module 280 may train the self-learned backbone network through supervised learning by using the labeled specific area images which are generated by the specific area detection module 270.

The labeled images which are stored in the labeled dataset 120 may be a data set for optimizing the backbone network for specific purposes (detecting, classifying, segmenting, etc.) with respect to a specific area, and a smaller amount of labeled images than the unlabeled data set used for self-learning may be implemented since the labeled images are used for supervised learning.

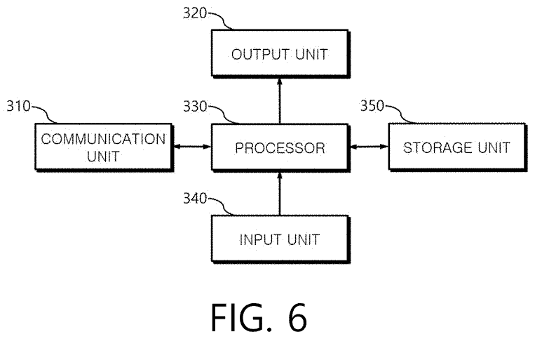

FIG. 6 is a view illustrating a hardware structure for implementing the learning system shown in FIG. 1.

As shown in FIG. 6, the learning system according to an embodiment may be implemented by a computing system established by including a communication unit 310, an output unit 320, a processor 330, an input unit 330, and a storage unit 250.

The communication unit 310 is a communication means for communicating with an external device and accessing an external network. The output unit 320 is a display for displaying a result of executing by the processor 330, and the input unit 330 is a user input means for delivering a user command to the processor 330.

The processor 330 is configured to perform functions of the modules 210 to 280 in the learning system shown in FIG. 1, and includes a plurality of graphics processing units (GPUs) and a central processing unit (CPU).

The storage unit 350 provides a storage space necessary for establishing the data sets 110, 120, and for the processor 330 to operate and function.

Up to now, optimized AI model learning method and system based on self-learning for focusing on specific areas have been described in detail with reference to preferred embodiments.

In the above-described embodiments, self-learning for focusing on a specific area in visual information is developed, and a learning method for acquiring optimal performance according to a purpose is suggested, and accordingly, self-learning considering image characteristics used for various purposes and high-performance image analysis based on self-learning are possible.

In particular, performance of deep learning-based face, object analysis may be remarkably enhanced through the disclosure.

The technical concept of the disclosure may be applied to a computer-readable recording medium which records a computer program for performing the functions of the apparatus and the method according to the present embodiments. In addition, the technical idea according to various embodiments of the present disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the art without departing from the scope of the present disclosure claimed in claims, and also, changed embodiments should not be understood as being separate from the technical idea or prospect of the present disclosure.

What is claimed is:

1. A network learning system comprising:
a detection module configured to detect a specific area from unlabeled images, and to generate unlabeled area images;
a configuration module configured to configure self-learning data by using the generated area images; and
a learning module to cause a backbone network to perform self-learning by using the configured self-learning data.

2. The network learning system of claim 1, wherein the specific area comprises a face area, an object area, a semantic area, and an entire area.

3. The network learning system of claim 1, further comprising a first selection module configured to select a backbone network to learn the configured self-learning data,
wherein the learning module is configured to cause the selected backbone network to perform self-learning.

4. The network learning system of claim 1, further comprising a second selection module configured to select a learning method for the backbone network to learn the self-learning data,
wherein the learning module is configured to cause the backbone network to perform self-learning in the selected learning method.

5. The network learning system of claim 4, wherein the learning method comprises a first learning method by which the backbone network learns to make an output of the backbone network follow an output of a target network, and a second learning method by which the backbone network learns while estimating an augmentation method of augmented self-learning data.

6. The network learning system of claim 5, wherein the configuration module is configured to configure unlabeled self-learning data by shuffling the area images when the first learning method is selected by the second selection module.

7. The network learning system of claim 5, wherein the configuration module is configured to configure self-learning data by augmenting the area images and labeling with an augmentation method when the second leaning method is selected by the second selection module.

8. The network learning system of claim 1, further comprising an optimization module configured to cause the self-learned backbone network to additionally learn with labeled area images.

9. The network learning system of claim 1, wherein a number of labeled images used for generating labeled area images is less than a number of unlabeled images.

10. A network learning method comprising:
detecting a specific area from unlabeled images, and generating unlabeled area images;
configuring self-learning data by using the generated area images; and
causing a backbone network to perform self-learning by using the configured self-learning data.

11. A network learning system comprising:
a database in which unlabeled images are stored;
a detection module configured to detect a specific area from the unlabeled images stored in the database, and to generate unlabeled area images;
a configuration module configured to configure self-learning data by using the generated area images; and
a learning module to cause a backbone network to perform self-learning by using the configured self-learning data.
